(19) United States
(12) Patent Application Publication
(10) Pub. No.: US 2022/0398450 A1
(43) Pub. Date: Dec. 15, 2022

(54) AUTOMATICALLY AND EFFICIENTLY GENERATING SEARCH SPACES FOR NEURAL NETWORK

(71) Applicant: Lemon Inc., Grand Cayman (KY)

(72) Inventors: Xiaojie JIN, Los Angeles, CA (US); Daquan Zhou, Singapore (SG); Xiaochen Lian, Los Angeles, CA (US); Linjie Yang, Los Angeles, CA (US); Jiashi Feng, Singapore (SG)

(21) Appl. No.: 17/348,246

(22) Filed: Jun. 15, 2021

(51) Int. Cl. G06N 3/08; G06N 3/12

(52) U.S. Cl. CPC G06N 3/08; G06N 3/126

(57) ABSTRACT

A super-network comprising a plurality of layers may be generated. Each layer may comprise cells with different structures. A predetermined number of cells from each layer may be selected. A plurality of cells may be generated based on selected cells using a local mutation model, wherein the local mutation model comprises a mutation window for removing redundant edges from each selected cell. Performance of the plurality of cells may be evaluated using a differentiable fitness scoring function. The operations of the generating a plurality of cells using the local mutation model, the evaluating performance of the plurality of cells using the differentiable fitness scoring function and the selecting the subset of cells based on the evaluation results may be iteratively performed until the super-network converges. A search space for each layer may be generated based on a predetermined top number of cells with largest fitness scores after the super-network converges.

### BACKGROUND

A neural network is a network of artificial neurons by simulating the human brain. A neural network may have many layers of “neurons” just like the neurons in the human brain. The first layer of neurons may receive inputs like images, video, sound, text, etc. This input data goes through all the layers, as the output of one layer is fed into the next layer. These networks can be incredibly complex and consist of millions of parameters to classify and recognize the input it receives. Accordingly, improvements in neural network generation techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system that may be used in accordance with the present disclosure.

FIG. 2 shows an example framework for generating search spaces.

FIG. 3 shows an example flowchart for generating search spaces.

FIG. 4 shows another example flowchart for generating search spaces.

FIG. 5 shows an example local mutator model.

FIG. 6 shows an example block diagram illustrating a comparison of various different search space generation techniques.

FIG. 7 shows an example table illustrating a comparison of various different search space generation techniques.

FIG. 8 shows an example chart illustrating a performance comparison of models generated using different search spaces.

FIG. 9 shows an example table illustrating an accuracy comparison of different search space generation techniques.

FIG. 10 shows an example table illustrating a comparison among search models based on an optimized search space and a manually designed search space.

FIG. 11 shows an example table illustrating performance of an optimized search space with different searching algorithms.

FIG. 12 shows an example graph illustrating a training loss curve of the evolution process with and without a reference directed acyclic graph (DAG).

FIG. 13 shows an example table illustrating a comparison of an optimized search space with existing state-of-the-art (SOTA) neural architecture search (NAS) algorithms.

FIG. 14 shows an example block diagram of four cell structures learned via an optimized search space.

FIG. 15 shows an example table illustrating a performance comparison between different baseline backbones on a validation set.

FIG. 16 shows an example computing device which may be used to perform any of the techniques disclosed herein.

### DETAILED DESCRIPTION OF ILLUSTRATIVE EMBODIMENTS

Neural Architecture Search (NAS) automates network architecture engineering. It aims to learn a network topology that can achieve best performance on a certain task. NAS may be characterized as a system with three major components: search space, search strategy, and evaluation strategy/performance estimation. NAS finds a network architecture from all possible architectures in the search space using a search strategy that will maximize the performance. Previous improvements in NAS have focused on search strategy and/or evaluation strategy/performance estimation. Improvements in search space design techniques are desirable.

Many popular and successful network architectures are designed by human experts. However, finding the optimal network architecture for performing a certain task may be easier if a systematic and automatic way of learning high-performance model architectures is adopted. Neural Architecture Search (NAS) does just that—it automates network architecture engineering and increases the chance that the optimal network architecture is selected for performing a certain task. For example, a NAS system may be provided with a dataset and a task (classification, regression, etc.), and it may output the optimal architecture for performing that task when trained by the provided dataset. Recent state-of-the-art (SOTA) deep neural networks highly rely on NAS algorithms.

A NAS system may be characterized as a system with three major components: search space, search strategy, and evaluation strategy/performance estimation. The NAS search space defines a set of operations (e.g. convolution, fully-connected, pooling, identity mapping, etc.) and how these operations may be connected to form valid network architectures. The NAS search strategy (e.g. algorithm) samples a population of network architecture candidates. It receives the child model performance metrics as rewards (e.g. high accuracy, low latency) and optimizes to generate high-performance architecture candidates. The NAS evaluation strategy/performance estimation may measure, estimate, or predict the performance of a large number of proposed child models in order to obtain feedback for the search algorithm to learn.

Some NAS systems deploy an open search space with minimal manual constraints. These systems offer a strong exploration capability for finding high-performing network architectures. For example, a NAS system may define its search space via macro and micro architectures. The macro architecture may be used for connections between layers and the micro architecture space may include the structural hyper-parameters for each filter within a layer. However, directly searching for network architectures within such a huge search space is time consuming. Additionally, utilizing such a huge search space increases the risk that a sub-optimal network architecture may be selected by the system.

Some NAS systems adopt a size-reduced search space to improve the searching efficiency. For example, some cell-based methods achieve affordable cost by searching only two types of cell structure, such as a normal cell and a reduction cell, which are shared across all layers for constructing a neural network. However, such cell-based methods can only search on a small proxy dataset due to high memory cost.

To reduce the size and complexity of the search space and lift the lower bound of the performance of the searched network architectures, some NAS systems utilize human expertise. For example, some more recent SOTA NAS systems leverage manually designed building blocks to design more compact search spaces, most of which are based on well-performing handcrafted building blocks and their variants (e.g. the inverted residual block with varying kernel sizes and expansion ratios and/or the channel shuffling block). Using such restricted search spaces may enable NAS systems to enjoy higher efficiency. However, despite offering improved efficiency, heavy human interference limits the NAS system's ability to discover novel and perhaps better-performing network architectures. Additionally, a manually predefined search space may not be optimal, as search spaces should be task specific.

Significant improvements have been made in both search strategy and evaluation strategy/performance estimation. For example, for evaluation strategy/performance estimation, the process of candidate evaluation may be very expensive and new methods have been proposed to save time or computation resources. As another example, improvements in search strategy have been made in order to address the high computation cost associated with traditional search strategy techniques. However, no such improvements have been made in the design of search spaces despite search space design being essential to the performance of the NAS system—the design of search spaces still relies heavily on human expertise. Accordingly, a technique for automating search space design is desirable.

Automating search space design may be challenging. For example, the complexity of the exploration space may make it difficult to automate search space design. As another example, the computation cost associated with evaluating the quality of different search spaces may be high. To address these challenges, a differentiable evolutionary framework for NAS may be utilized. This differentiable evolutionary framework may take in the dimensions of a target network and output a layer-wise search space that is able to produce more accurate network architectures as compared with previous NAS systems.

This differentiable evolutionary framework may begin with a full search space on the target data set that comprises all of the possible combinations of basic operations (e.g. convolution, fully-connected, pooling, identity mapping, etc.) and how these operations may be connected to form valid network architectures. Then, a differentiable evolutionary algorithm (DEA) may be applied to evolve the full search space into an optimal subspace (e.g. a subset of high-quality cell structures learned from the full space) for the target applications, through jointly optimizing the subspace and corresponding network architectures. The optimal subspace may then be seamlessly integrated into any NAS system to find the optimal network architecture for performing that particular task. By searching for an optimal subspace first, then later performing NAS within that optimal subspace, exploration capability and searching efficiency may be improved, while avoiding getting suck at the sub-optimum.

In an embodiment, this differentiable evolutionary framework may evolve the search space into an optimal search space using three models (e.g. sub-systems). These three models may remove the redundancy and improve the parallelism of the evolution process. The first of the three models may be a local mutator. The local mutator model may remove redundant cell structures from the full population of cell structures from which the search space is designed. By removing redundant cell structures, the efficiency of the NAS system may prove. The second of the three models may be a reference directed acrylic graph (DAG) model. The reference DAG model may utilize a reference network architecture during mutation in order to speed up the evolutionary process and to avoid falling into sub-optimal solutions. The last of the three models may be a differentiable scoring function. The differentiable scoring function may efficiently evaluate the performance of mutated cells through gradient optimization techniques.

This differentiable evolutionary framework may be compatible with additional computational constraints, making it feasible to learn specialized search spaces that fit different computational budgets. The performance of recent NAS systems improves significantly with the learned search space as opposed to manually designed search spaces. For example, the network architectures generated from the learned search space achieve 77.78% top-1 accuracy on ImageNet under the mobile setting (MAdds≤500 M), outperforming previous SOTA EfficientNet-B0 by 0.68%.

NAS may be utilized to automate the design of neural networks for a variety of different applications in a variety of different disciplines. Application areas include, for example and without limitation, system identification and control (vehicle control, trajectory prediction, process control, natural resource management), quantum chemistry, general game playing, pattern recognition (radar systems, face identification, signal classification, 3D reconstruction, object recognition and more), sequence recognition (gesture, speech, handwritten and printed text recognition), medical diagnosis, finance (e.g. automated trading systems), data mining, visualization, machine translation, social network filtering, and e-mail spam filtering.

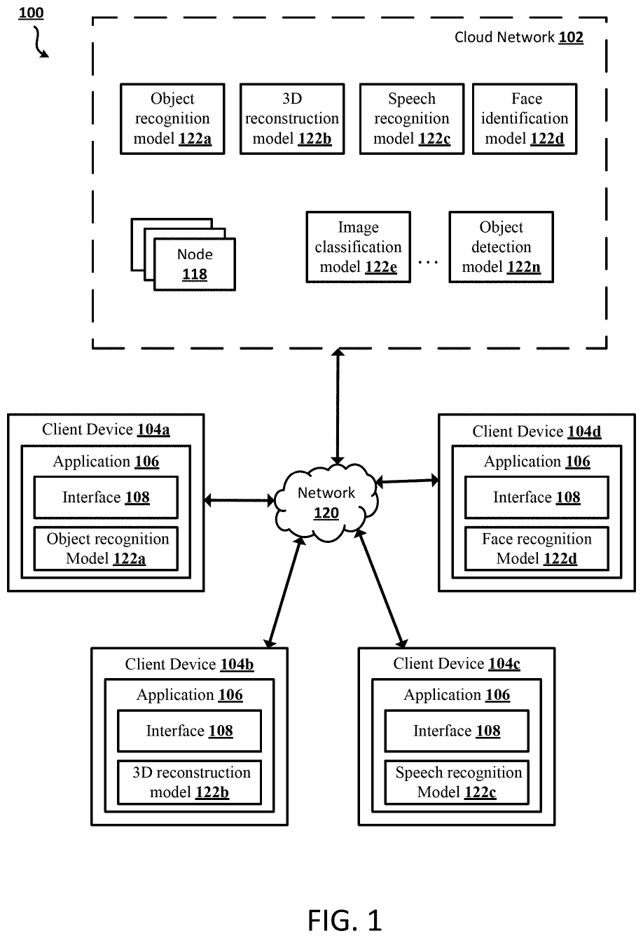

The neural networks generated utilizing NAS may be integrated into and/or utilized by a variety of different systems. FIG. 1 illustrates an example system 100 into which the neural networks generated in accordance with the present disclosure may be integrated. The system 100 may comprise a cloud network 102 or a server device and a plurality of client devices 104a-d. The cloud network 102 and the plurality of client devices 104a-d may communicate with each other via one or more networks 120. The cloud network 102 may be located at a data center, such as a single premise, or be distributed throughout different geographic locations (e.g., at several premises). The cloud network 102 may provide the services via the one or more networks 120. The network 120 comprise a variety of network devices, such as routers, switches, multiplexers, hubs, modems, bridges, repeaters, firewalls, proxy devices, and/or the like. The network 120 may comprise physical links, such as coaxial cable links, twisted pair cable links, fiber optic links, a combination thereof, and/or the like. The network 120 may comprise wireless links, such as cellular links, satellite links, Wi-Fi links and/or the like. In an embodiment, a user may use an application 106 on a client device 104, such as to interact with the cloud network 102. The client devices 104 may access an interface 108 of the application 106.

The plurality of computing nodes 118 may process tasks associated with the cloud network 102. The plurality of computing nodes 118 may be implemented as one or more computing devices, one or more processors, one or more virtual computing instances, a combination thereof, and/or the like. The plurality of computing nodes 118 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

In an embodiment, at least one of the cloud network or server device 102 or the client devices 104 comprise one or more neural networks. NAS may have been utilized to automate the design of these one or more neural networks. For example, NAS may have been utilized to automate the generation of an object recognition model 122a, a 3D reconstruction model 122b, a speech recognition model 122c, and/or a face identification model 122d, an image classification model 122e, an object detection model 122n, and/or any other type of neural network. Other neural networks not depicted in FIG. 1 may additionally, or alternatively, be included in at least one of the cloud network or server device 102 or the client devices 104.

The object recognition model 122a, the 3D reconstruction model 122b, the speech recognition model 122c, the face identification model 122d, the image classification model 122e, and/or the object detection model 122n may be utilized, at least in part, to perform various pattern recognition related tasks. For example, The object recognition model 122a, the 3D reconstruction model 122b, the speech recognition model 122c, the face identification model 122d, the image classification model 122e, and/or the object detection model 122n may be utilized, for example, to perform pattern recognition related tasks during or after the creation of a video before it is uploaded to a content service. Additionally, or alternatively, these models may be utilized to perform pattern recognition related tasks after uploading of the video to the content service.

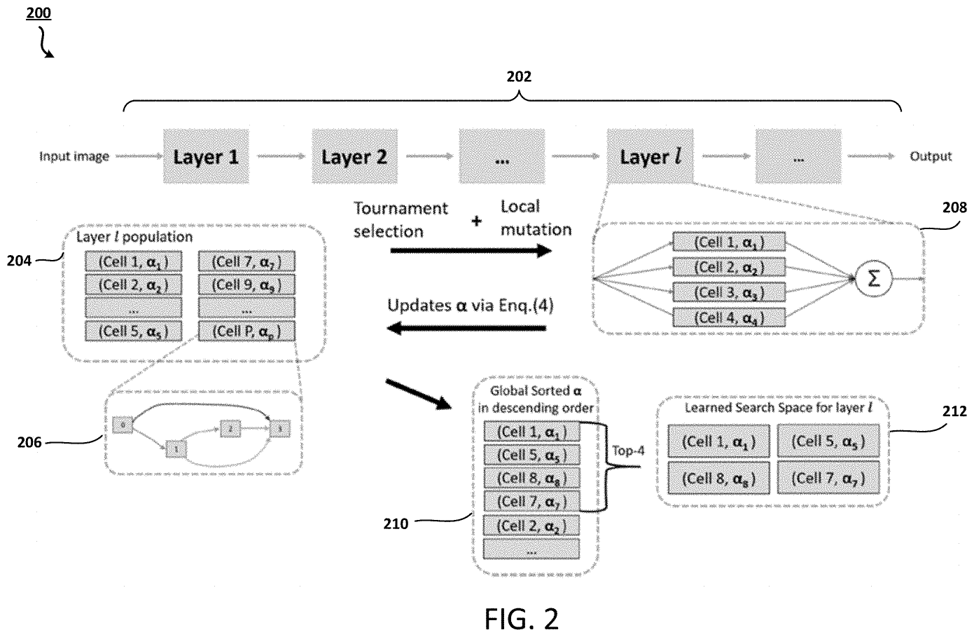

As discussed above, NAS is a technique for automating the generation of neural networks, a widely used model in the field of machine learning. NAS has been used to generation networks that are on par or outperform hand-designed architectures. Methods for NAS can be categorized according to the search space, search strategy and performance estimation strategy used. The search space defines the type(s) of neural network that can be optimized. FIG. 2 illustrates a framework 200 for generating an optimized search space for a NAS system. By first optimizing the search space, the neural network generated by the NAS may perform better than a neural network that is designed based on a non-optimized, manually designed search space.

The framework 200 may include an L-layer classification super-network (“supernet”) 202. A supernet may be a network of networks. For example, a supernet may include a plurality of sub-networks. These sub-networks may be merged with the last layer of the supernet—which is also trained. The supernet 202 may include L-layers, with a 3×3 convolutional layer as the head and one fully connected layer as the classifier. The number of layers L in the supernet 202 may be equal to the number of layers in a target network. In one example, the target network may be a neural network for image classification, such as the image classification model 122e. In another example, the target network may be a neural network for object detection, such as object detection model 122n. By way of example and without limitation, an image may be input into a trained target network, and the trained target network may output a result of image classification or a result of object detection. A target network's architecture may be formed based on an optimized search space generated using the framework 200. Each layer L in the supernet 202 may include K parallel paths. K may be any number. The value of K may, for example, be based on the channel dimension of the target network.

The framework 200 may include a layer cell population 204 for each layer L in the supernet 202. The layer cell population 204 may include a plurality of candidate cells. Each candidate cell may be a candidate to form an optimized search space for generating the target network.

The candidate cells in the layer cell population 204 may each have a structure. The candidate cells in the layer cell population 204 may each have a different structure, or some of the candidate cells in the layer cell population 204 may have the same or a similar structure. The structure of each candidate cell may be represented by, for example, a directed acrylic graph (DAG). For example, in the layer call population 204, the structure of candidate cell P is represented by a DAG 206. A DAG is a directed graph with no directed cycles. That is, it consists of nodes and edges (also called arcs), with each edge directed from one node to another, such that following those directions will never form a closed loop. For example, in the DAG 206, the blocks represent nodes, and the edges are represented by the lines and arcs that connect the blocks. Each node xᵢ of a DAG, such as the DAG 206, may be the output feature representation from a certain edge, and each directed edge may be associated with some operation that transforms the input xᵢ to xⱼ.

In an embodiment, to minimize human effect on the framework 200, there may be no constraints specified on the node connection topology for the candidate cells in each layer cell population 204, except that two nodes may be specified as input and output of the DAG. The edge connections may be learned with the framework 200. For each edge, five basic operations, denoted as o, are considered: 1×1 convolution of C channels, 3×3 convolution of C channels, depthwise convolution, identify mapping, and the zero operation. o(G_{g}) may denote the selected operators between a node i and j. The input and output nodes are used as dimension adjustment nodes, and the ratios between the input and output channels are learned by the framework 200. The aggregation function o_{f} over the output features from different operators may be selected from {addition, dot product}.

The layer cell population 204 may be updated and evaluated via a differentiable, evolutionary algorithm (DEA). A typical (e.g. non-differentiable) evolutionary algorithm consists of three steps. The first step is to generate a population of the cells with different structures (i.e., different DAG connection topologies), such as the layer cell population 204. The second step is to apply a scoring function to evaluate each individual candidate cell in a tournament randomly selected from the population, where the winner candidate cells with the largest K fitness scores are allowed to generate off-springs via mutation. The third step is to generate new off-springs via mutation between the selected cells to enrich and improve the layer cell population 204. The last two steps are performed in an iterative manner. At the end of evolution, the top K performing cells from the layer cell population 204 may be used as the layer-wise search space.

However, the typical (e.g. non-differentiable) evolutionary algorithm described above cannot be directly used to search for an optimal subspace within the layer-wise search space. An optimal subspace may be a subspace of the search space containing cells with optimized architecture such that the constructed model architecture can achieve maximum accuracy on the target dataset at affordable computation cost (in MAdds). To solve for an optimal subspace within a sufficiently large layer-wise search space, the following may be solved:

$${S}_{sub}^{k} = {arg max}_{{S}_{sub} ⊂ S} {max}_{d ∈ {S}_{sub}} Acc ( N ( d , {S}_{sub} ) , 𝒟 ) , \qquad ( 1 )$$

$$s . t . MAdds ( di ) < {MAdds}_{max} , ∀ {d}_{i} ,$$

wherein N(d, S_{sub}) denotes the network searched from the subspace S_{sub} and d={d1, d2 . . . } denotes the set of selected cells for all the layers. MAddsₘₐₓ denotes the upper limit of the allowed MAdds of cell dᵢ. In particular, we consider searching for different subspaces at different layers of an L-layer model architecture, i.e., S_{sub}=Πᵢ₌₁^{L}Sⁱ and dᵢ∈Sⁱ (i=1, . . . , L).

The typical (non-differentiable) evolutionary algorithm described above cannot be directly used to solve Equation 1 and search for a subspace due to the following challenges. First, a large redundancy exits in the layer cell population 204, incurring high computation overhead. Second, a one-by-one evaluation for the subspace is extremely time consuming. Third, a typical (non-differentiable) evolutionary process starts from scratch and is slow to converge. To solve these challenges, the framework 200 may adopt a differentiable, evolutionary algorithm (DEA) to remove the redundant cells, speedup the convergence and increase the parallelism for subspace evaluation.

The DEA may resemble the typical evolutionary algorithm described above, but may be different than the typical evolutionary algorithm in three major ways: (1) the DEA may utilize a local mutation technique to remove redundant cell structures from the layer cell population, (2) the DEA may utilize a differentiable fitness scoring function to efficiently evaluated the performance of mutated cells through gradient optimization techniques, and (3) the DEA may leverage a reference architecture (reference DAG) during mutation to speed up the evolution procedure and avoid falling into sup-optimal solutions. Each of these three techniques is discussed in more detail below.

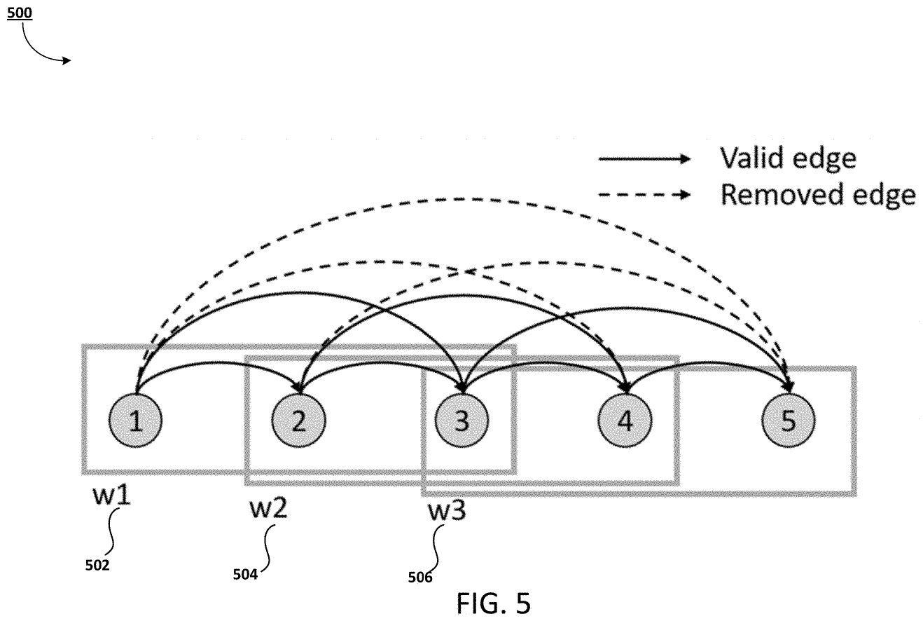

The DEA may utilize a local mutation technique instead of the traditional mutation technique utilized by typical evolutionary algorithm. A traditional mutation technique may mutate a DAG by mutating the directed edges in the DAG. However, for a DAG with V-nodes, there will be a total of ½V(V−1) directed edges. Enumerating and evaluating all of the possible mutations amongst them, for each DAG in the layer cell population 204 will be time-consuming. The local mutation technique addresses this issue by reducing the graph connection redundancy (and thus reducing the number of possible mutations for each DAG). For example, instead of considering all of the possible edges for mutation, the local mutation mechanism covers only a portion of V′ consecutive nodes in a V-node DAG, where V′<V. For example, for a 5-node DAG, V′ might be 3. The local mutation technique is discussed in more detail below, with regard to FIG. 5.

Typical evolutionary algorithms take a long time to converge (e.g. complete the evolution process) because they evolve from scratch. It is difficult to interface with typical evolutionary algorithms and inject them with valuable human knowledge that we possess—which forces the evolutionary process to evolve from scratch. However, the DEA may be injected with useful prior knowledge to speed up the evolution process. The prior knowledge injected into the DEA may be a reference architecture (e.g. reference DAG) set at initialization. The reference DAG may be the DAG of a verified well-performing cell structure. The local mutation process described above (and in more detail below with regard to FIG. 5) may repeat until the DAG of the mutated cell and the reference DAG are similar enough to each other.

To determine the similarity between the DAG of the mutated cell and the reference DAG, a hamming distance between the DAG of the mutated cell and the reference DAG may be calculated after each mutation. Hamming distance is used as a measure of similarity between DAGS. The hamming distance may be calculated as follows:

$${r}_{H} ( G , {G}^{ref} ) = {\sum }_{i , j} \frac{\vert {G}_{i , j} - {G}_{i , j}^{ref} \vert}{V ( V - 1 )} , \qquad ( 2 )$$

wherein G_{ref} is the reference DAG and G the DAG of the mutated cell. The mutation process will repeat until the hamming distance is below a predetermined threshold. In an embodiment, this reference DAG regularization is only applied for the first half iterations of the entire training process to avoid adversely affecting the learning of a better search space.

As discussed above, the second step in a typical evolutionary algorithm is to apply a scoring function to evaluate each individual candidate cell in a tournament randomly selected from the population, where the winner candidate cells with the largest K fitness scores are allowed to generate off-springs via mutation. However, the traditional methods used to evaluate the performance of candidate cells are not applicable with the framework 200 because different cell structures are allowed to be used at different layers in the supernet 202. This leads to an explosive increase in the size of search space. There is also no one-to-one correspondence between the network performance and quality of the cell-structure.

To address these issues with traditional cell performance evaluation methods, the DEA learns the fitness score for each individual candidate cell via gradient optimization. Gradient optimization methods, such as gradient descent, are methods of optimizing a function or operation. Gradient descent is a first-order iterative optimization algorithm for finding a local minimum of a differentiable function or operation. The local minimum of the differentiable function optimizes the function or operation. Gradient descent methods take repeated steps in the opposite direction of the gradient (or approximate gradient) of the function or operation at the current point because this is the direction of steepest descent. By heading in the direction of steepest descent, the local minimum may be reached. The DEA learns the fitness score for each individual candidate cell via gradient optimization to optimize the operation shown in Equation 1, above.

The framework 200 may include a differentiable fitness scoring function 208. The differentiable fitness scoring function 208 may calculate a weighted sum of the outputs of the mixing (e.g. generating off-spring) of K cells. The output of each sampled cell structure from the population will be weighted by its fitness score in the constructed supernet 202. To calculate the weighted sum of the outputs of the mixing of K cells, the following equation may be used:

$${f}_{{S}^{l}} = {\sum }_{k = 1}^{K} {p}_{k} {d}_{k} ( x ) = {\sum }_{k = 1}^{K} \frac{{α}_{k}^{l}}{{\sum }_{j} {α}_{j}^{l}} {d}_{k} ( x ) \qquad ( 3 )$$

Wherein pₖ is the weight for each cell structure dₖ in the supernet 202, and f_{S}¹ is evaluated by computing its classification loss over the provided training dataset. In this manner, multiple individuals at different layers may be evaluated concurrently. To save the computation memory, a binary gating function may be employed when learning the fitness score for each selected cell.

The fitness scores for the selected K cells in each layer cell population 204 may be updated by gradient back-propagation when training the supernet 202 to minimize the cross-entropy loss on the target dataset. In fitting a neural network, backpropagation computes the gradient of the loss function with respect to the weights of the network for a single input—output example, and does so efficiently, unlike a naive direct computation of the gradient with respect to each weight individually. Backpropagation works by computing the gradient of the loss function with respect to each weight by the chain rule, computing the gradient one layer at a time, iterating backward from the last layer to avoid redundant calculations of intermediate terms in the chain rule.

To alleviate the imbalanced gradient updates on the fitness scores in each layer cell population 204 due to the random sampling in tournament selection, the gradient update step of the fitness score for each cell structure may be compensated via a scaling factor based on the training iteration number:

$$\frac{\partial L}{\partial {α}_{i}^{l}} \approx {\sum }_{k = 1}^{K} \frac{\partial L}{\partial {g}_{k}} {p}_{k} ( {δ}_{i , k} - {p}_{i} ) \frac{n ( {d}_{i}^{l} )}{{d}^{′} ( {d}_{i}^{l} )} \qquad ( 4 )$$

Wherein gₖ is the binary gate as introduced in Equation 1, and δᵢₖ=1 if i=k and 0 otherwise. n(dᵢ^{l}) denotes the accumulative training iteration numbers in the supernet 202 and n′(dᵢ^{l}) denotes the accumulative training iteration number attached for (dᵢ^{l}) in the entire layer cell population 204.

After training the supernet 202 for a few iterations, the updated fitness scores in the supernet 202 may be used to update the fitness scores of the corresponding cell structures in the layer cell population 204 as below:

αₖ^{l}^{^{(t)}}=ϵα_{b}^{l}*+(1−ϵ)αₖ^{l}^{^{(t−1)}}, (5)

wherein ϵ∈[0,1] is the momentum hyperparameter for updating the fitness score. ∝^{(t-1)} denotes the old fitness score recorded in the population before the updates.

The supernet 202 may be re-generated every f iterations via the local mutation. When sampling the new search space, the fitness scores and the cell structures are sampled in pairs. The fitness scores for each selected cell structure in each population will be updated iteratively via Equation 4 and Equation 5 until the supernet converges. After the evolution, the top-K cell structures at each layer will be selected to form the search space. In this way, each training of the supernet will evaluate KL network structures concurrently and thus the evolution process is sped up by KL times compared to sequential evaluation.

The overall framework 200 operates as follows: a layer cell population 204 is maintained for each layer of the supernet 202. The DEA process may begin by randomly selecting an assortment of cells (e.g. the initial population) from the layer cell population 204. Then, tournament selection is performed on the initial population. Tournament selection is a method of selecting an individual cell from a population of cells. Tournament selection involves running several “tournaments” among a few cells chosen at random from the population. The winner of each tournament (the one with the best fitness score) is selected for crossover. The cells that “win” each tournament may be able to generate new “off-spring” cells via local mutation. A differentiable fitness scoring function may be utilized to efficiently evaluate the performance of these “off-spring” cells generated via local mutation. The differentiable fitness scoring function may allow the framework 200 to learn the fitness score for each cell structure via gradient optimization.

After the DEA process, for each layer, the framework 200 may determine which cells in the layer cell population 204 are the best-performing cells (e.g. have the best fitness scores). The framework 200 may generate a global sorted list 210. The global sorted list 210 may list, in descending order of fitness scores, the cells in the layer cell population 204. The K cells at the beginning or top of the global sorted list 210 may be chosen to form a learned search space 212 for that layer. The framework may determine a learned search space 212 for each layer in order to generate the optimized layer-wise search space. Each parallel path in each layer L may be associated with a candidate cell in the corresponding layer-wise search space. The above described process need only be run once for a target dataset and the generated search space may be used by any searching algorithm.

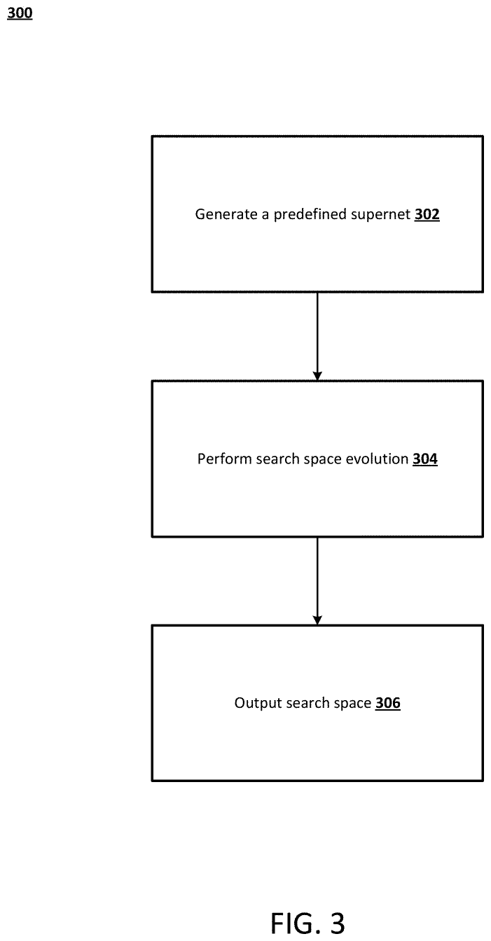

FIG. 3 illustrates a process 300 for generating a search space for a NAS system. The method 300 may be performed, for example, by the framework 200 described above with respect to FIG. 2. Although depicted as a sequence of operations in FIG. 3, those of ordinary skill in the art will appreciate that various embodiments may add, remove, reorder, or modify the depicted operations.

As discussed above, a framework may include an L-layer classification super-supernet (e.g. supernet 202). At 302, a predetermined supernet may be generated. A supernet may be a network of networks. For example, a supernet may include a plurality of sub-networks. These sub-networks may be merged with the last layer of the supernet—which is also trained. The supernet 202 may include L-layers, with a 3×3 convolutional layer as the head and one fully connected layer as the classifier. The number of layers L in the supernet may be equal to the number of layers in a target network. A target network may be a neural network whose architecture will be designed via a NAS system utilizing an optimized search space generated using the framework 200. Each layer L in the supernet may include K parallel paths. K may be any number. The value of K may, for example, be based on the channel dimension of the target network.

A layer cell population (e.g. layer cell population 204) may be maintained for each layer L in the supernet. The layer cell population for each layer L may include a plurality of candidate cells. Each candidate cell may be a candidate to form an optimized search space for designing the target network. The candidate cells in the layer cell population may each have a structure. The structure of each candidate cell may be represented by, for example, a DAG. The DEA process may be carried out by performing sampling-and-update iteratively on each layer cell population. At 304, search space evolution may be performed. The search space evolution may be performed, for example, by a differentiable, evolutionary algorithm (DEA), such as the DEA described above with respect to FIG. 2.

The DEA process may begin by randomly selecting an assortment of cells (e.g. the initial population) from the layer cell population. Then, tournament selection is performed on the initial population. As discussed above, tournament selection is a method of selecting an individual cell from a population of cells. Tournament selection involves running several “tournaments” among a few cells chosen at random from the population. The winner of each tournament (the one with the best fitness score) is selected for crossover. The cells that “win” each tournament may be able to generate new “off-spring” cells via local mutation.

As described above, a traditional mutation technique may mutate a DAG by mutating the directed edges in the DAG. However, for a DAG with V-nodes, there will be a total of ½V(V−1) directed edges. Enumerating and evaluating all of the possible mutations amongst them, for each DAG in the layer cell population 204 will be time-consuming. The local mutation technique addresses this issue by reducing the graph connection redundancy (and thus reducing the number of possible mutations for each DAG). For example, instead of considering all of the possible edges for mutation, the local mutation mechanism covers only a portion of V′ consecutive nodes in a V-node DAG, where V′<V. For example, for a 5-node DAG, V′ might be 3. The local mutation technique is discussed in more detail below, with regard to FIG. 5. The local mutator may receive, as input, a DAG associated with cells that “win” each tournament and generate off-spring of those DAGS.

The mutated cells may be evaluated by a differentiable scoring function (e.g. differentiable fitness scoring function 208). The differentiable fitness scoring function may calculate a weighted sum of the outputs of the mixing (e.g. generating off-spring) of K cells. The output of each sampled cell structure from the population will be weighted by its fitness score in the constructed supernet. The performance of the weighted sum of the outputs of mixing these K cells is calculated, such as via Equation 3. Then, the fitness score for each cell may be updated in the layer cell population via gradient back-propagation. The fitness score for each cell may be updated in the layer cell population after this first iteration. For example, the fitness score for each cell may be updated via Equation 5. After the first iteration, this sampling and update may be performed iteratively until the supernet converges.

After the DEA process, for each layer, may be determined which cells in the layer cell population are the best-performing cells (e.g. have the best fitness scores). A global sorted list (e.g. global sorted list 210) may be generated. The global sorted list may list, in descending order of fitness scores, the cells in the layer cell population. The K cells at the beginning or top of the global sorted list may be chosen to form a learned search space for that layer. A learned search space may be determined for each layer in order to generate the optimized layer-wise search space. At 306, the optimized layer-wise search space may be output. The learned search space may be applied to various NAS algorithms.

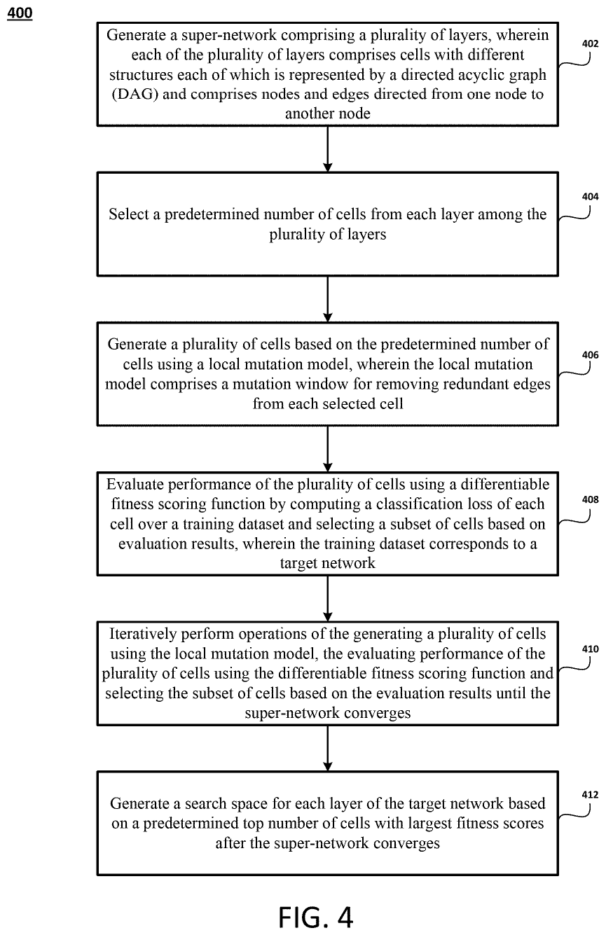

FIG. 4 illustrates an example process 400 for generating a search space for a NAS system. The process 400 may be performed, for example, by the framework 200 described above with respect to FIG. 2. Although depicted as a sequence of operations in FIG. 4, those of ordinary skill in the art will appreciate that various embodiments may add, remove, reorder, or modify the depicted operations.

At 402, a super-network (“supernet) comprising a plurality of layers may be generated. Each of the plurality of layers of the supernet may comprise cells with different structures. Each structure may be represented by a directed acyclic graph (DAG), each DAG may comprise nodes and edges directed from one node to another node. In an example, the supernet (e.g. supernet 202) may include L-layers, with a 3×3 convolutional layer as the head and one fully connected layer as the classifier. The number of layers L in the supernet may be equal to the number of layers in a target network. A target network may be a neural network whose architecture will be designed via a NAS system utilizing an optimized search space generated using the framework 200. Each layer L in the supernet may include K parallel paths. K may be any number. The value of K may, for example, be based on the channel dimension of the target network. In an embodiment, the cells associated with each of the plurality of layers may be a layer cell population (e.g. layer cell population 204. The layer cell population for each layer L may include a plurality of candidate cells. Each candidate cell may be a candidate to form an optimized search space for the target network.

The DEA process may be carried out by performing sampling-and-update iteratively on each layer cell population. At 404, a predetermined number of cells may be selected from each layer among the plurality of layers. The predetermined number of cells may be randomly selected from the layer cell population associated with each layer. Then, tournament selection may be performed on the predetermined number of cells. As discussed above, tournament selection is a method of selecting an individual cell from a population of cells. Tournament selection involves running several “tournaments” among a few cells chosen at random from the population. The winner of each tournament (the one with the best fitness score) is selected for crossover. The cells that “win” each tournament may be able to generate new “off-spring” cells via local mutation.

At 406, a plurality of cells may be generated based on the predetermined number of selected cells using a local mutation model. The local mutation model may comprise a mutation window for removing redundant edges from each selected cell. As is discussed in more detail with regard to FIG. 5 below, the local mutation technique may be conducted in three steps. First, a mutation window, may be set at a randomly selected node in the DAG. Instead of considering all the possible edges for a V-node DAG, a mutation window only covers a set of V′ consecutive nodes (with V′<V) and progressively moves across all the nodes within the DAG. Only the nodes lying within the mutation window may be considered for the mutation process. For a V-node DAG, there will be overall V-V′+1 mutation windows. Second, a predecessor node I and a successor node j may be randomly selected within the mutation window. This may be determined for each of the mutation windows. Third, the edge between the randomly selected predecessor nodes and successor nodes may be replaced with a randomly sampled operation from the following operations: 1×1 convolution of C channels, 3×3 convolution of C channels, depth wise convolution, identify mapping, and the zero operation.

In an embodiment, to take the computation budget into consideration, MAdds constraints may be added during local mutation. Specifically, the local mutation process may be repeated until the MAdds of the generated cell structure is less than the predefined layer-wise threshold. As discussed above, the local mutation may continue until the similarity between the DAG of the mutated cell and a reference DAG is below a predetermined threshold. This reference DAG regularization may only be applied for the first half iterations of the entire training process to avoid adversely affecting the learning of a better search space.

The reference DAG may be the DAG of a verified well-performing cell structure. The local mutation process described above (and in more detail below with regard to FIG. 5) may repeat until the DAG of the mutated cell and the reference DAG are similar enough to each other. To determine the similarity between the DAG of the mutated cell and the reference DAG, a hamming distance between the DAG of the mutated cell and the reference DAG may be calculated after each mutation. Hamming distance is used as a measure of similarity between DAGS. The hamming distance may be calculated using Equation 2, above. The mutation process may repeat until the hamming distance is below a predetermined threshold. In an embodiment, this reference DAG regularization is only applied for the first half iterations of the entire training process to avoid adversely affecting the learning of a better search space.

At 408, the performance of the plurality of cells may be evaluated using a differentiable fitness scoring function by computing a classification loss of each cell over a training dataset and selecting a subset of cells based on evaluation results. The training dataset may correspond to the target network.

A differentiable fitness scoring function (e.g. differentiable fitness scoring function 208) may calculate a weighted sum of the outputs of the mixing (e.g. generating off-spring) of the plurality of cells. The output of each sampled cell structure from the population will be weighted by its fitness score in the constructed supernet. Multiple individuals at different layers may be evaluated concurrently. To save the computation memory, a binary gating function may be employed when learning the fitness score for each selected cell. The fitness scores for the plurality of cells in each layer cell population may be updated by gradient back-propagation when training the supernet to minimize the cross-entropy loss on the target dataset.

At 410, the above-described operations of generating a plurality of cells using the local mutation model, evaluating the performance of the plurality of cells using the differentiable fitness scoring function, and selecting the subset of cells based on the evaluation results may be iteratively performed until the supernet converges. After the evolution, the top-K cell structures at each layer will be selected to form the search space. In this way, each training of the supernet will evaluate K^{L} network structures concurrently and thus the evolution process is sped up by K^{L} times compared to sequential evaluation. At 412, a search space may be generated and/or output for each layer of the target network based on a predetermined top number of cells with largest fitness scores. The search space may be generated and/or output after the supernet converges.

FIG. 5 illustrates a local mutation technique 500 that may be performed by a DEA, such as the DEA utilized by the framework 200 of FIG. 2. As discussed above, a traditional mutation technique may mutate a DAG by mutating the directed edges in the DAG. However, for a DAG with V-nodes, there will be a total of ½V(V−1) directed edges. Enumerating and evaluating all of the possible mutations amongst them, for each DAG in the layer cell population may be time-consuming. The local mutation technique 500 addresses this issue by reducing the graph connection redundancy (and thus reducing the number of possible mutations for each DAG). For example, instead of considering all of the possible edges for mutation, the local mutation mechanism covers only a portion of V′ consecutive nodes in a V-node DAG, where V′<V. For example, for a 5-node DAG, V′ might be 3.

The local mutation technique 500 may be conducted in three steps. First, a mutation window, such one of the mutation windows 502, 504, 506, may be set at a randomly selected node in the DAG. Instead of considering all the possible edges for a V-node DAG, a mutation window only covers a set of V′ consecutive nodes (with V′<V) and progressively moves across all the nodes within the DAG. For example, a 5-node DAG, such as the DAG depicted in FIG. 5, may cover 3 consecutive nodes. The mutation window 502 covers the consecutive nodes labeled “1”-“3”. Only the nodes lying within the mutation window may be considered for the mutation process. For a V-node DAG, there will be overall V-V′+1 mutation windows. For example, the DAG illustrated in FIG. 5 has 5 nodes and 3 mutation windows 502, 504, 506.

Second, a predecessor node I and a successor node j may be randomly selected within the mutation window. This may be determined for each of the mutation windows. Third, the edge between the randomly selected predecessor nodes and successor nodes may be replaced with a randomly sampled operation from the following operations: 1×1 convolution of C channels, 3×3 convolution of C channels, depth wise convolution, identify mapping, and the zero operation. The solid lines in FIG. 5 denote the edges that are kept for mutation while the dotted lines denote edges connecting the nodes outside the mutation window and are removed from mutation. The dependency of the size of populations on the node number becomes linear.

In an embodiment, to take the computation budget into consideration, MAdds constraints may be added during local mutation. Specifically, the local mutation process may be repeated until the MAdds of the generated cell structure is less than the predefined layer-wise threshold. As discussed above, the local mutation may continue until the similarity between the DAG of the mutated cell and a reference DAG is below a predetermined threshold. This reference DAG regularization may only applied for the first half iterations of the entire training process to avoid adversely affecting the learning of a better search space.

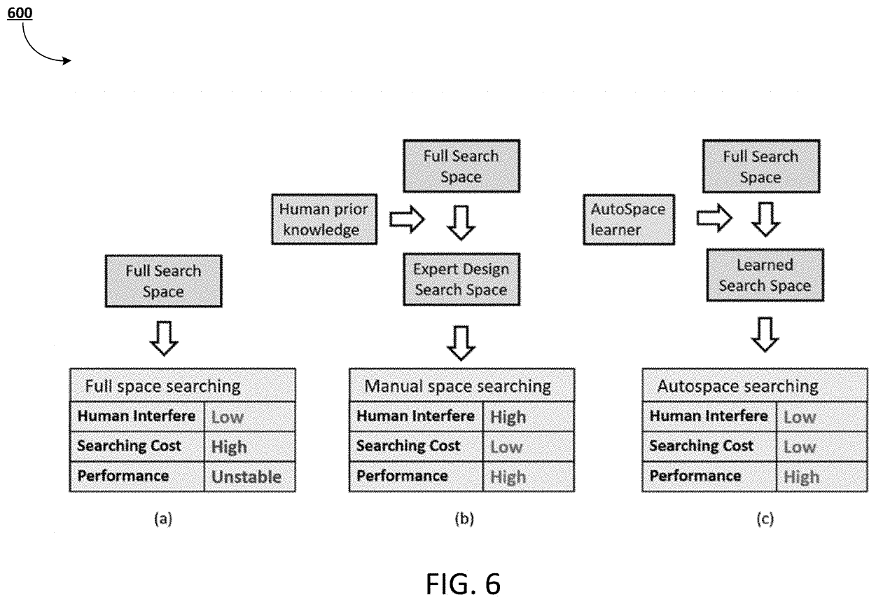

FIG. 6 shows an example block diagram 600 illustrating a comparison of design strategy for various different search space generation techniques. The diagram 600 illustrates the differences between the search space evolving strategy described above and previous techniques for generating search spaces. The block diagram (a) illustrates that early NAS algorithms perform architecture search in a full search space. While the human interference with these early NAS algorithms is low, the searching cost is high and the performance is unreliable/unstable. The block diagram (b) illustrates that recent SOTA NAS algorithms adopt a manually designed search space. While the searching cost associated with these recent SOTA NAS algorithms is low and the performance high, the human interference is high. The block diagram (c) illustrates the design strategy for the search space evolving strategy described above. The search space evolving strategy described above first searches for a subspace from the full space and then uses the learned search space for further architecture search. This strategy outperforms the NAS algorithms represented by (a) and (b), in that the human interference is low, the searching cost is low, and the performance is high.

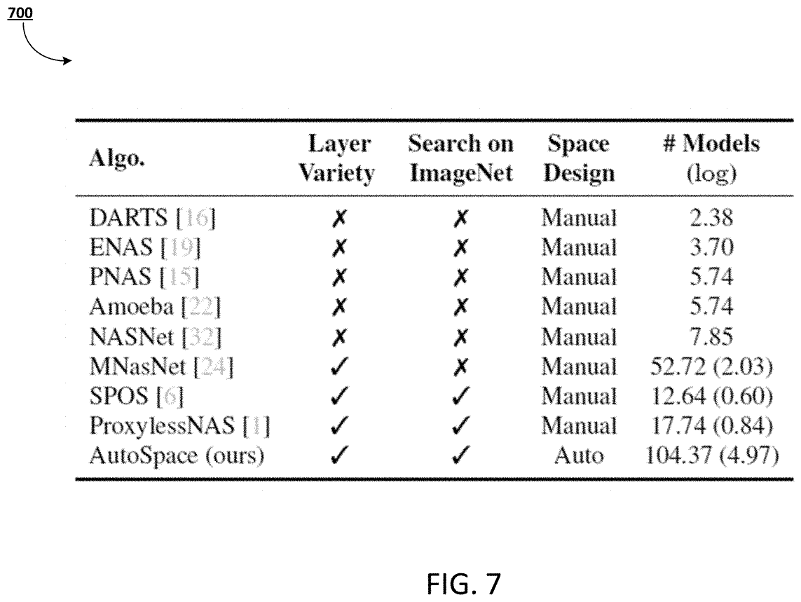

FIG. 7 shows an example table 700 illustrating a comparison of the design choices of various different search space generation techniques. A comparison of the choices of search space generation strategy described above and previous SOTAs are listed in the table 700. The number of design choices in the search space generation strategy described above eclipses the previous algorithms' search space. The search space generation strategy described above automatically finds an optimized subspace of comparable size to the algorithms denoted by [1] and [24].

The “Layer Variety” column indicates if the searching algorithms allow different cell structures at different model layers. The search space generation strategy described above allows for different cell structures at different model layers, unlike the first five strategies in the table 700. The “Models (log)” column denotes the log 10 value of the total number of architectures included in the search space for a 21-layer model. For the algorithms supporting layer variety, the number in the parentheses in the last column denotes the number of cell structures in each layer's space. The search space generation strategy described above has more cell structures (4.97) than the other algorithms that support layer variety.

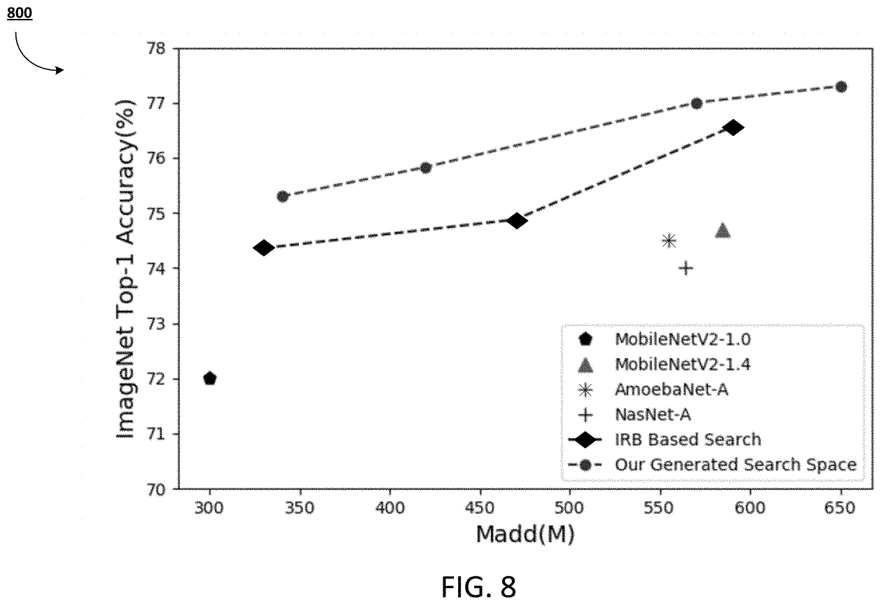

FIG. 8 shows an example chart 800 illustrating a performance comparison of models generated using various different search spaces. The performance of the models searched from the search space generated by the strategy described above are represented by the dashed line with circles. As shown in chart 800, the models searched from the search space designed by the strategy described above significantly outperform those using manually designed search spaces. Those manually designed search spaces are mostly inverted residual blocks with varying kernel sizes and expansion ratios. Accordingly, by directly replacing the original search space with the learned search space, the top-1 classification accuracy of previous SOTA NAS algorithms may be improved significantly at different model sizes. For example, at 200 M MAdds, the performance of the searched model is improved by more than 1.8% on ImageNet and at 400 M MAdds.

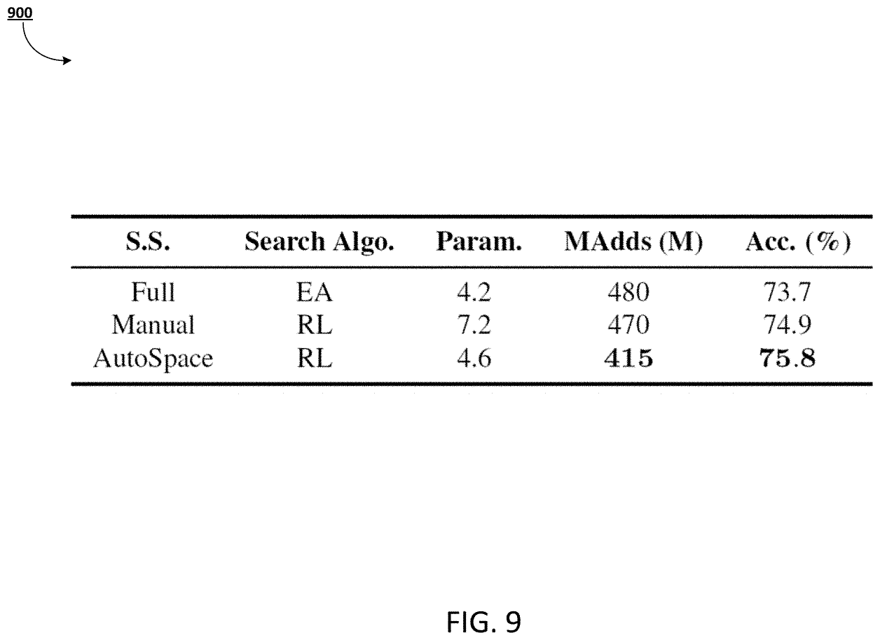

FIG. 9 shows an example table 900 illustrating an accuracy comparison of models searched using different searching strategies. For example, the table 900 illustrates the Top-1 classification accuracy comparison of different searching strategies. ‘S.S’ denotes the search space. ‘Full’ denotes the full search space as the search space designed using the above-described method. ‘Manual’ denotes the manually designed search space.

The table 900 shows that the model searched by the above described method outperforms the baseline models significantly, in terms of both top-1 classification accuracy and computational efficiency. This indicates two interesting things. First, the superiority over the direct searching strategy demonstrates that the above described method may generate a high-quality search space that enables the subsequent NAS algorithm to search for better network architectures. Second, compared with the handcrafted search space, the search space generated using the above-described technique may be optimized jointly with the model architecture on the target dataset. The above described method may thus learn better task-specific models and benefit from the end-to-end training pipeline.

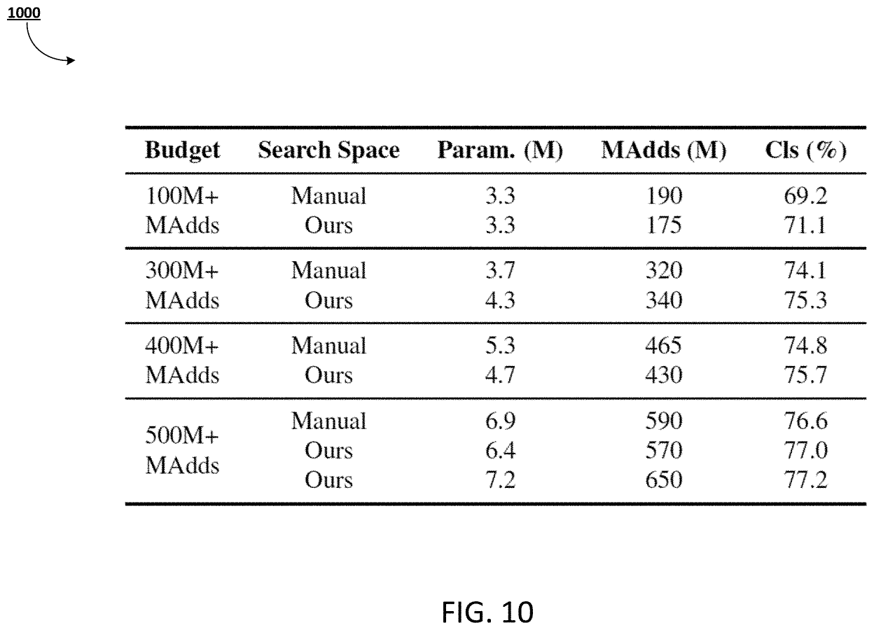

FIG. 10 shows an example table 1000 illustrating a comparison among search models designed based on an optimized search space, such as one designed using the above-described techniques, and a manually designed search space. For example, the table 1000 illustrates a comparison among the searched models based on the optimized search space and the manually designed (‘manual’) search space by ProxylessNAS. ‘Cls’ denotes the Top-1 classification accuracy on ImageNet.

To provide a more comprehensive comparison between the optimized search space and the manually designed search space, we the above-described technique may be used to generate a layer-wise search spaces on ImageNet. Then, the ProxylessNAS gradient-based (G) searching algorithms may be run with different MAdds regularizations, obtaining models of sizes spanning 100-200 M (100 M+), 300-400 M (300 M+), 400-500 M (400 M+) and 500-700 M (500 M+) respectively. The regularization is added to both the search space generation and architecture searching process.

The table 1000 shows that, for each model size constraint, the searched model from the optimized search space always outperforms the ones from the manually designed search spaces by a large margin with the same searching algorithm. A key advantage of the above-described method is that the optimized search space is optimized for each layer on the target dataset. This means that the optimized search space may be more likely to contain superior model structures than a manually designed search space that includes identical operators across layers.

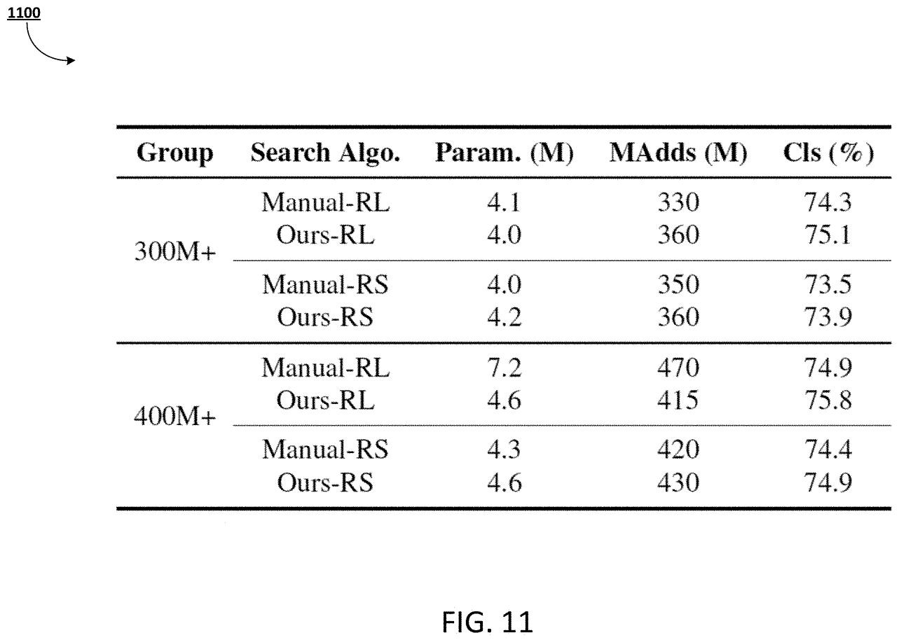

FIG. 11 shows an example table 1100 illustrating performance of an optimized search space with different searching algorithms. ‘Manual’ denotes the manually designed search space. ‘RL’ denotes reinforcement learning based algorithms as used in ProxylessNAS. ‘RS’ denotes the random searching algorithm as used in SPOS, and ‘Cls’ denotes the Top-1 classification accuracy on ImageNet.

To verify the generality of the search space learned by the above-described technique, different searching algorithms may be run on it on it, as well as on the baseline search space to compare the resulted models. Two representative searching algorithms which are based on reinforcement learning (RL) and random sampling (RS) may be chosen. The results are shown in the table 1100. Under different computation budgets, the model searched using the optimized search space significantly outperforms the ones from the baseline search space. For example, in the group with 300 M+ Madds, the model searched using the optimized search space outperforms competing models searched by RL and RS by 0.8% and 0.4% respectively. This result further verifies the superiority of the auto-learned search space.

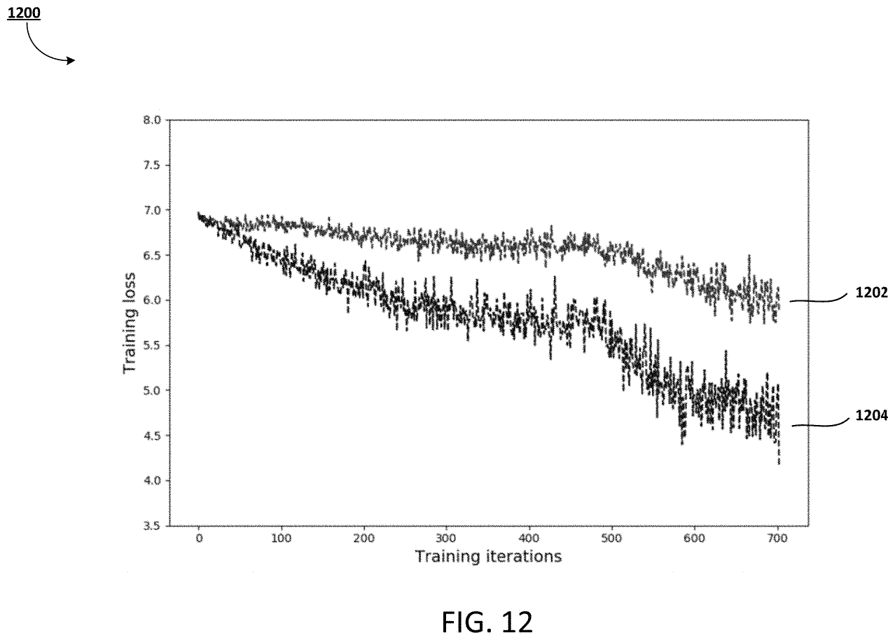

FIG. 12 shows an example graph 1200 illustrating a training loss curve of the evolution process with and without a reference directed acyclic graph (DAG). The curve 1202 is representative of the training loss curve of the evolution process without a reference DAG. The curve 1204 is representative of the training loss curve of the evolution process with a reference DAG, such as the reference DAG described above. As shown in the graph 1200, the convergence of the evolution process is faster with the reference graph. As an example, the reference graph regularization may be used for the first 60 epochs and disabled for the rest of the evolution iterations.

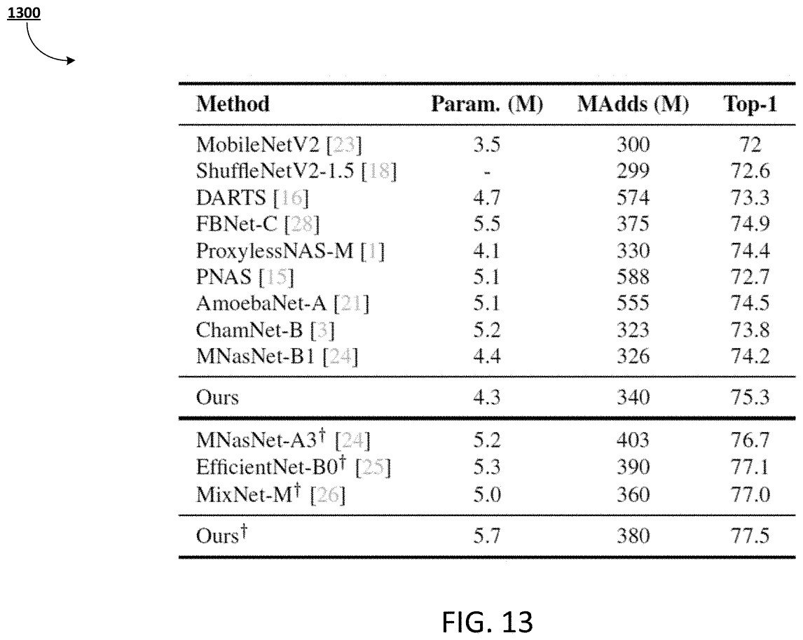

FIG. 13 shows an example table 1300 illustrating a comparison of an optimized search space with existing state-of-the-art (SOTA) neural architecture search (NAS) algorithms. The table 1300 illustrates a comparison of the optimized search space with previous SOTA NAS algorithms. The model delineated as “ours” is obtained by applying ProxylessNAS onto the auto-generated optimized search space. For fair comparison, the method was split into two groups, i.e., without SE or with SE (labeled with ‘y’).

Each time the layer-wise subspace is updated by the differentiable evolutionary algorithm (DEA), the fitness score for each cell will be updated together with the cell structures based on the records in the population. Thus, during training, it is expected that the fitness score can accurately reflect the relative advantages among selected cell structures. To study the ranking accuracy of the differentiable fitness scoring function, three different networks with known top-1 classification accuracy may be sampled on ImageNet. DEA may then be used to rank the three networks with different initial fitness scores. It is experimentally verified that DEA is able to rank the networks correctly according to their representation learning capability.

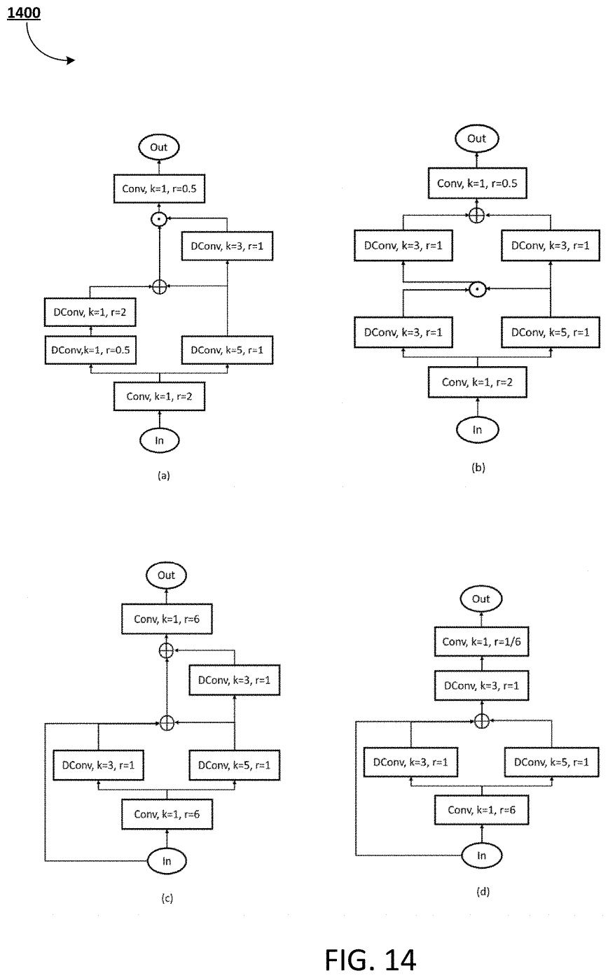

FIG. 14 shows an example block diagram 1400 of four cell structures learned via an optimized search space. The four cell structures (a)-(d) represent the four most frequently selected cell structures learned via the above described technique. In the figure, ‘DConv’ denotes depthwise convolution. ‘k’ denotes the kernel size and ‘r’ denotes the ratio between the output channel and the input channel of a convolution layer. ⊙ denotes the dot product of two feature maps and ‘⊕’ denotes element-wise addition of two feature maps. Among the four cell structures, (d) is selected most often.

ProxylessNAS may be followed to use the single path searching algorithm for searching model architectures from the auto-learned search space. Then, our model may be compared with other models obtained by manual design or popular NAS algorithms. For fair comparison, compared models may be divided into two groups: models without SE modules and models with SE and extra data augmentation techniques. In each group, our model outperforms other models in terms of top-1 accuracy with less or comparable computation cost. As aforementioned, this improvement may result from the high-quality cell structures learned with the proposed search space generation method. To further verify this, common characteristics appeared in the learned search space may be summarized. Among all the learned cell structures, we observe that (d) is the most frequently selected. To further investigate the performance of structure (d), all of the DEA learned cells may be replaced with (d) and SE modules may be added in the same manner as EfficientNet-B. Without using excessive data augmentation methods, the modified model achieves 77.78% Top-1 classification, accuracy on ImageNet, outperforming the, EfficientNet-B0 model by 0.68%.

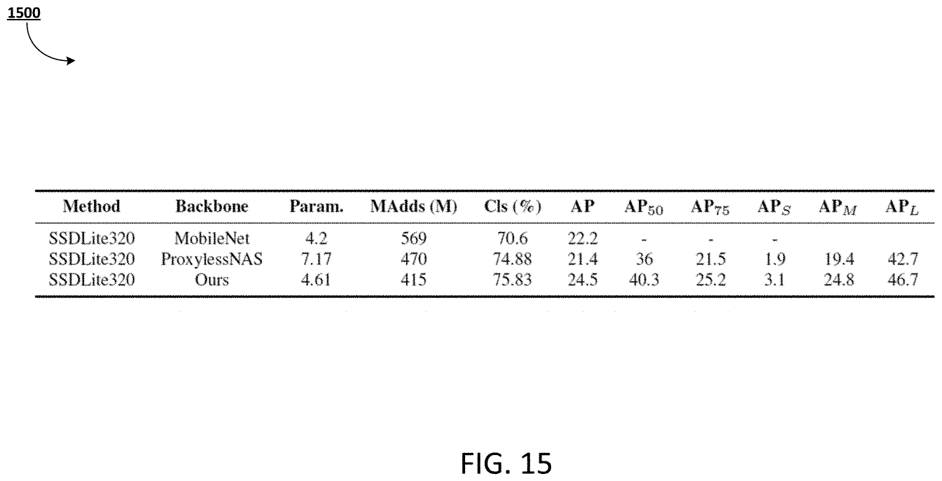

FIG. 15 shows an example table 1500 illustrating a performance comparison between different baseline backbones on a validation set. The table 1500 illustrates a comparison with a baseline backbone on COCO object detection and instance segmentation. ‘Cls’ denotes the Top-1 classification accuracy on ImageNet. mAP denotes the mean average precision for objection detection on COCO. The above-described method is compared with ProxylessNAS and MobileNet models on object detection to explore the task transfer capability of the searched model from the auto-generated search space. In Table 1500, the results of different models on COCO 2017 validation set are compared. Besides the AP score, results in terms of AP50, AP75, APS, APM, and APL are also reported in the table 1500. As can be seen, with less computation cost, SSDLite equipped with our searched backbone network achieves better results on all metrics compared to SSDLite with MobileNet and ProxylessNAS. The above experiments demonstrate that the auto-learned search space has strong generality for other vision tasks like object detection, not limited in image classification.

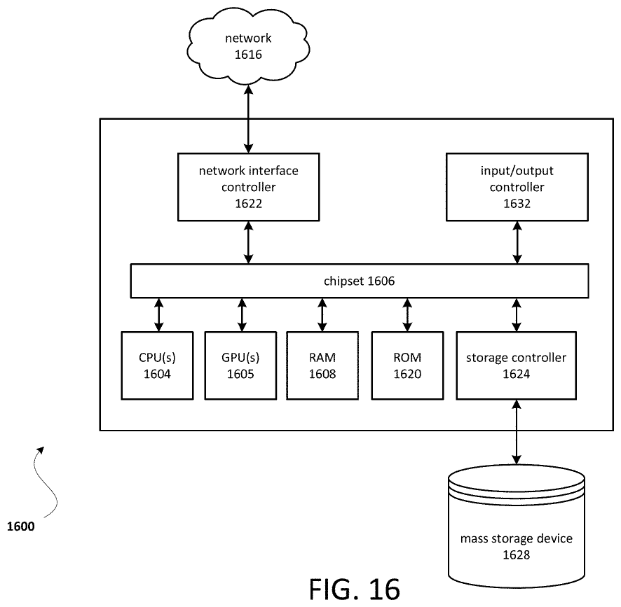

FIG. 16 illustrates a computing device that may be used in various aspects, such as the services, networks, modules, and/or devices depicted in FIG. 1. With regard to the example architecture of FIG. 1, the cloud network or a server device 102 and client devices 104a-d may each be implemented by one or more instance of a computing device 1600 of FIG. 16. The computer architecture shown in FIG. 16 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1600 may include a baseboard, or “motherboard,” which is a printed circuit board to which a multitude of components or devices may be connected by way of a system bus or other electrical communication paths. One or more central processing units (CPUs) 1604 may operate in conjunction with a chipset 1606. The CPU(s) 1604 may be standard programmable processors that perform arithmetic and logical operations necessary for the operation of the computing device 1600.

The CPU(s) 1604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1604 may be augmented with or replaced by other processing units, such as GPU(s) 1605. The GPU(s) 1605 may comprise processing units specialized for but not necessarily limited to highly parallel computations, such as graphics and other visualization-related processing.

A chipset 1606 may provide an interface between the CPU(s) 1604 and the remainder of the components and devices on the baseboard. The chipset 1606 may provide an interface to a random-access memory (RAM) 1608 used as the main memory in the computing device 1600. The chipset 1606 may further provide an interface to a computer-readable storage medium, such as a read-only memory (ROM) 1620 or non-volatile RAM (NVRAM) (not shown), for storing basic routines that may help to start up the computing device 1600 and to transfer information between the various components and devices. ROM 1620 or NVRAM may also store other software components necessary for the operation of the computing device 1600 in accordance with the aspects described herein.

The computing device 1600 may operate in a networked environment using logical connections to remote computing nodes and computer systems through local area network (LAN). The chipset 1606 may include functionality for providing network connectivity through a network interface controller (NIC) 1622, such as a gigabit Ethernet adapter. A NIC 1622 may be capable of connecting the computing device 1600 to other computing nodes over a network 1616. It should be appreciated that multiple NICs 1622 may be present in the computing device 1600, connecting the computing device to other types of networks and remote computer systems.

The computing device 1600 may be connected to a mass storage device 1628 that provides non-volatile storage for the computer. The mass storage device 1628 may store system programs, application programs, other program modules, and data, which have been described in greater detail herein. The mass storage device 1628 may be connected to the computing device 1600 through a storage controller 1624 connected to the chipset 1606. The mass storage device 1628 may consist of one or more physical storage units. The mass storage device 1628 may comprise a management component 1610. A storage controller 1624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1600 may store data on the mass storage device 1628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1628 is characterized as primary or secondary storage and the like.

For example, the computing device 1600 may store information to the mass storage device 1628 by issuing instructions through a storage controller 1624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1600 may further read information from the mass storage device 1628 by detecting the physical states or characteristics of one or more particular locations within the physical storage units.

In addition to the mass storage device 1628 described above, the computing device 1600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1628 depicted in FIG. 16, may store an operating system utilized to control the operation of the computing device 1600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1628 may store other system or application programs and data utilized by the computing device 1600.

The mass storage device 1628 or other computer-readable storage media may also be encoded with computer-executable instructions, which, when loaded into the computing device 1600, transforms the computing device from a general-purpose computing system into a special-purpose computer capable of implementing the aspects described herein. These computer-executable instructions transform the computing device 1600 by specifying how the CPU(s) 1604 transition between states, as described above. The computing device 1600 may have access to computer-readable storage media storing computer-executable instructions, which, when executed by the computing device 1600, may perform the methods described herein.

A computing device, such as the computing device 1600 depicted in FIG. 16, may also include an input/output controller 1632 for receiving and processing input from a number of input devices, such as a keyboard, a mouse, a touchpad, a touch screen, an electronic stylus, or other type of input device. Similarly, an input/output controller 1632 may provide output to a display, such as a computer monitor, a flat-panel display, a digital projector, a printer, a plotter, or other type of output device. It will be appreciated that the computing device 1600 may not include all of the components shown in FIG. 16, may include other components that are not explicitly shown in FIG. 16, or may utilize an architecture completely different than that shown in FIG. 16.

As described herein, a computing device may be a physical computing device, such as the computing device 1600 of FIG. 16. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of automatically and efficiently generating search spaces for a target network, comprising:
generating a network comprising a plurality of layers, wherein each of the plurality of layers comprises cells with different structures each of which is represented by a directed acyclic graph (DAG) that comprises nodes and edges directed from one node to another node;
generating a plurality of cells based on a predetermined number of cells selected from each of the plurality of layers using a local mutation model, wherein the local mutation model comprises a mutation window for removing redundant edges from each selected cell;
evaluating performance of the plurality of cells using a differentiable fitness scoring function by computing a classification loss of each cell over a training dataset and selecting a subset of cells based on evaluation results, wherein the training dataset corresponds to the target network; and
generating a search space for each layer of the target network based on a predetermined top number of cells with largest fitness scores.

2. The method of claim 1, further comprising:
iterating operations of generating a plurality of cells using the local mutation model, evaluating performance of the plurality of cells using the differentiable fitness scoring function and selecting the subset of cells based on the evaluation results until the network converges.

3. The method of claim 2, further comprising:
applying a reference DAG to a first half iteration of an entire process, wherein the reference DAG is a verified well performing cell structure.

4. The method of claim 3, further comprising:
determining a hamming distance between a generated DAG and the reference DAG after each mutation, wherein the hamming distance is indicative of similarities between DAGs; and
repeating a mutation process until the hamming distance between a generated DAG and the reference DAG is below a threshold.

5. The method of claim 1, further comprising:
setting the mutation window at a randomly selected node;
selecting a predecessor node i and a successor node j within the window; and
replacing an edge G_{i,j} between the predecessor node i and the successor node j with an operation selected from a set of predetermined basic operators.

6. The method of claim 5, wherein the predetermined set of basic operators comprise 1×1 convolution of C channels, 3×3 convolution of C channels, depth-wise convolution, identity mapping, and zero operation.

7. The method of claim 1, wherein the evaluating performance of the plurality of cells using a differentiable fitness scoring function further comprises:
determining a fitness core for each selected cell via gradient optimization.

8. The method of claim 7, wherein an output of each selected cell is weighted by its corresponding fitness score.

9. The method of claim 1, wherein the target network is a network for image classification or a network for object detection.

10. A system, comprising:
at least one processor; and
at least one memory communicatively coupled to the at least one processor to configure the system at least to perform operations comprising:
generating a network comprising a plurality of layers, wherein each of the plurality of layers comprises cells with different structures each of which is represented by a directed acyclic graph (DAG) that comprises nodes and edges directed from one node to another node;
generating a plurality of cells based on a predetermined number of cells selected from each of the plurality of layers using a local mutation model, wherein the local mutation model comprises a mutation window for removing redundant edges from each selected cell;
evaluating performance of the plurality of cells using a differentiable fitness scoring function by computing a classification loss of each cell over a training dataset and selecting a subset of cells based on evaluation results, wherein the training dataset corresponds to the target network; and
generating a search space for each layer of the target network based on a predetermined top number of cells with largest fitness scores.

11. The system of claim 10, the operations further comprising:
iterating operations of generating a plurality of cells using the local mutation model, evaluating performance of the plurality of cells using the differentiable fitness scoring function and selecting the subset of cells based on the evaluation results until the network converges.

12. The system of claim 11, the operations further comprising:
applying a reference DAG to a first half iteration of an entire process, wherein the reference DAG is a verified well performing cell structure.

13. The system of claim 12, the operations further comprising:
determining a hamming distance between a generated DAG and the reference DAG after each mutation, wherein the hamming distance is indicative of similarities between DAGs; and
repeating a mutation process until the hamming distance between a generated DAG and the reference DAG is below a threshold.

14. The system of claim 10, the operations further comprising:
setting the mutation window at a randomly selected node;
selecting a predecessor node i and a successor node j within the window; and
replacing an edge G_{i,j} between the predecessor node i and the successor node j with an operation selected from a set of predetermined basic operators.

15. The system of claim 10, the evaluating performance of the plurality of cells using a differentiable fitness scoring function further comprises:
determining a fitness core for each selected cell via gradient optimization.

16. The system of claim 15, wherein an output of each selected cell is weighted by its corresponding fitness score.

17. A non-transitory computer-readable storage medium, storing computer-readable instructions that upon execution on a computing device cause the computing device to perform operations comprising:
generating a network comprising a plurality of layers, wherein each of the plurality of layers comprises cells with different structures each of which is represented by a directed acyclic graph (DAG) that comprises nodes and edges directed from one node to another node;
generating a plurality of cells based on a predetermined number of cells selected from each of the plurality of layers using a local mutation model, wherein the local mutation model comprises a mutation window for removing redundant edges from each selected cell;
evaluating performance of the plurality of cells using a differentiable fitness scoring function by computing a classification loss of each cell over a training dataset and selecting a subset of cells based on evaluation results, wherein the training dataset corresponds to the target network; and
generating a search space for each layer of the target network based on a predetermined top number of cells with largest fitness scores.

18. The non-transitory computer-readable storage medium of claim 17, the operations further comprising:
iterating operations of generating a plurality of cells using the local mutation model, evaluating performance of the plurality of cells using the differentiable fitness scoring function and selecting the subset of cells based on the evaluation results until the network converges; and
applying a reference DAG to a first half iteration of an entire process, wherein the reference DAG is a verified well performing cell structure.

19. The non-transitory computer-readable storage medium of claim 17, the operations further comprising:
setting the mutation window at a randomly selected node;
selecting a predecessor node i and a successor node j within the window; and
replacing an edge G_{i,j} between the predecessor node i and the successor node j with an operation selected from a set of predetermined basic operators.

20. The non-transitory computer-readable storage medium of claim 17, wherein the evaluating performance of the plurality of cells using a differentiable fitness scoring function further comprises determining a fitness core for each selected cell via gradient optimization, and wherein an output of each selected cell is weighted by its corresponding fitness score.
